(19) United States
(12) Patent Application Publication
(10) Pub. No.: US 2026/0306886 A1
(43) Pub. Date: Oct. 8, 2026

(54) REAL-TIME FIRE MANAGEMENT SYSTEM

(71) Applicants: Britton Coulson, Port Alberni (CA); Wayne Coulson, Port Alberni (CA)

(72) Inventors: Britton Coulson, Port Alberni (CA); Wayne Coulson, Port Alberni (CA)

(21) Appl. No.: 19/448,714

(22) Filed: Jan. 14, 2026

Related U.S. Application Data
(60) Provisional application No. 63/783,631, filed on Apr. 4, 2025.

(51) Int. Cl. A62C 3/08; A62C 37/00

(52) U.S. Cl. CPC A62C 3/08; A62C 37/00

(57) ABSTRACT

The present disclosure includes an aircraft including a sensor configured to output a first signal corresponding to a characteristic of a fire; and a processor configured to determine a current boundary of the fire based on the first signal, and configured to receive a second signal corresponding to current fire suppression data. The processor is configured to determine a recommended fire suppression method based on the current boundary of the fire and the current suppression data for the fire.

### CROSS REFERENCE TO RELATED APPLICATIONS

This application claims the benefit of and priority to U.S. Provisional Appl. No. 63/783,631, filed Apr. 4, 2025, which is incorporated herein in its entirety by reference.

### FIELD

The present disclosures relates to fire management systems. In particular, the present disclosure relates to fire management systems that provide firefighting personnel with real-time analytics to improve decision making.

### BACKGROUND

Efforts to combat fires (e.g., wildfires) typically include firefighting personnel on the ground and firefighting equipment. Firefighting equipment can include ground vehicles and/or aircraft configured to deploy fire retardant (e.g., water or other fire suppression material) over an area of or around the fire. Characteristics of fires (e.g., area, growth rate, intensity, spread pattern/direction, etc.) can change while firefighting personnel attempt to contain and extinguish the fire due to, for example, environmental conditions such as changes in wind and humidity.

### SUMMARY

Combating and preventing the spread of wildfires (e.g., aerial firefighting management) is a uniquely challenging problem because it requires urgent and rapid decision making and action in a dynamic physical environment (e.g., changing natural conditions and unpredictable technical issues such as diminished aircraft performance, communication network drop outs, sensor failures, etc., while coordinating multiple technological resources (e.g., aircraft, ground vehicles, airborne sensors, ground-based sensors, etc.) with varied performance capabilities and functions. Additionally, combating and preventing the spread of wildfires often involves strategic decisions based on situation-specific objectives (e.g., protect structures vs. wildlife, controlled burns, etc.) Existing fire management systems are inadequate because they do not communicate (e.g., to firefighting personnel) a holistic real-time evaluation of the fire, ongoing efforts to extinguish or contain the fire, and/or available alternative resources or methods to extinguish or contain the fire.

As discussed in detail below, the embodiments disclosed herein improve firefighting technology by evaluating a combination of fire state data, current suppression data, and/or available suppression resources and methods to evaluate characteristics of the fire, assess the effectiveness of the current suppression methods, predict fire future characteristics, and/or to recommend alternative suppression resources and methods. Combining fire state data, current suppression data, and/or available suppression resources and methods as disclosed herein improves the technologies available to firefighting personnel, such as aircraft and ground vehicles deployed to combat the fire, and computing devices configured to display information regarding the fire. For example, the systems disclosed herein integrate aircraft and ground operations (e.g., vehicles and personnel) into a communication network that yields improved insights to reduce fuel burn and waste (e.g., inefficient retardant use), and makes the aircraft and ground operations more effective in extinguishing or maintaining the fire. As another example, the systems disclosed herein integrate computing devices (e.g., mobile device, tablet) into a communication network with available resources (e.g., aircraft, ground vehicles, personnel, etc.) to communicate uniquely valuable predictions and/or recommendations to firefighting personnel to improve decision making.

Integrating technologies available to firefighting personal (e.g., aircraft, ground vehicles, sensors, communications systems, computing devices, etc.) into the holistic system disclosed herein increases situational awareness for firefighting personnel. For example, the embodiments disclosed herein communicate the effectiveness of a current suppression method, predicted fire characteristics, and/or recommended suppression resources and methods to firefighting personnel, which are valuable insights that otherwise would not be available or effective (e.g., would not provide recommendations based on holistic inputs in a timely manner that supports urgent responses to active fires) if based solely on human observations, reporting, etc.

The present disclosure includes a fire management system. In some embodiments, the fire management system includes an aircraft and a computing system including a processor. In some embodiments, the processor is configured to receive signals corresponding to at least one of current fire state data for a fire and current suppression data for the fire. In some embodiments, the processor is configured determine current boundaries of the fire based on the current fire state data. In some embodiments, the processor is configured to predict the boundaries of the fire after a predetermined time based on the current boundaries of the fire and, the current suppression data.

In some embodiments, the processor is configured to output signals corresponding to the current boundaries of the fire and the predicted boundaries of the fire to a user interface. In some embodiments, the processor is configured to receive an image output by an image capture device on the aircraft.

In some embodiments, the fire management system includes a computing system including a processor, and the processor is configured to receive signals corresponding to at least one of current fire state data for a fire and current suppression data for the fire. In some embodiments, the processor is configured to output a recommended suppression method based on at least one of the current fire state data and the current suppression data.

In some embodiments, the present disclosure includes a firefighting ground station. In some embodiments, the firefighting ground station includes a processor configured to receive a signal corresponding to at least one of current fire state data for a fire and current suppression data for the fire. In some embodiments, the firefighting ground station includes a user interface configured to display a first layer including a first map corresponding to a perimeter of the fire, and configured to display a second layer including a second map corresponding to a projected perimeter of the fire over a predetermined time period.

In some embodiments, the present disclosure includes an aircraft including a sensor configured to output a first signal corresponding to a characteristic of the fire, and a processor configured to determine a current boundary of the fire based on the first signal and configured to receive a second signal corresponding to current fire suppression data. In some embodiments, the processor is configured to determine a recommended fire suppression method based on the current boundary of the fire and the current suppression data for the fire.

In some embodiments, the aircraft comprises a transmitter configured to output a recommendation signal corresponding to the recommended fire suppression method. In some embodiments, the transmitter is configured to output the recommendation signal to a ground station, and the ground station includes a user interface configured to output the recommended fire suppression method. In some embodiments, the transmitter is configured to output the recommendation signal to a second aircraft.

In some embodiments, the aircraft includes a user interface configured to output the recommended fire suppression method. In some embodiment, the user interface is configured to display the current boundary of the fire. In some embodiments, the sensor is an image capture device. In some embodiments, the aircraft is configured to automatically execute a flight plan corresponding to the recommended fire suppression method.

In some embodiments, the present disclosure includes an aerial firefighting management system including an aircraft, a ground station, and a computing device including a processor. In some embodiments, the processor is configured to receive a first signal corresponding to current fire state data for a fire and a second signal corresponding to current fire suppression data. In some embodiments, the processor is configured to determine a recommended suppression method based on the current fire state data and the current fire suppression data. In some embodiments, the processor is configured to determine a current fire boundary based on the current fire state data, and the processor is configured to determine a predicted fire boundary based on the current fire state data and the current fire suppression data.

In some embodiments, the processor is disposed at the ground station. In some embodiments, the ground station includes a user interface configured to display the current boundary of the fire and the predicted boundary of the fire. In some embodiments, the ground station is configured to receive input from the aircraft via a communication network. In some embodiments, the ground station is configured to receive an input corresponding to a fire suppression objective, and the processor is configured to determine the recommended suppression method based on the fire suppression objective.

In some embodiments, the current fire state data includes a characteristic of the fire or an environmental condition. In some embodiments, the characteristic of the fire includes at least one of a surface area of the fire, a direction of spread, or a fire growth rate, and the environmental condition includes at least one of ambient temperature, humidity, wind direction, wind velocity, fire weather index, cloud coverage, dew point, or topography. In some embodiments, the current suppression data includes at least one of a location of firefighting personnel, a location of the aircraft, a quantity of fuel onboard the aircraft, a retardant type onboard the aircraft, a retardant load onboard the aircraft, a coverage level, a fire area rate of change, or a rate of spread.

In some embodiments, the recommended suppression method includes a fire retardant coverage level. In some embodiments, the recommended suppression method includes a drop location for fire retardant. In some embodiments, the recommended suppression method includes a fire-retardant type and fire-retardant load. In some embodiments, the processor is configured to select the fire-retardant type from a plurality of predetermined fire-retardant types.

In some embodiments, the processor is configured to determine the recommended suppression method based on a prior suppression method result. In some embodiments, the aerial firefighting management system includes a performance analysis system configured to determine damage avoided by executing the recommended suppression method. In some embodiments, the performance analysis system is configured to assign a score to a flight crew. In some embodiments, the aircraft includes a first user interface, and the ground station includes a second user interface, the first user interface includes a first layer based on an assigned role of the aircraft, and the second user interface includes a second layer based on an assigned role of the ground station.

### BRIEF DESCRIPTION OF THE DRAWINGS/FIGURES

FIG. 1 is a system diagram of a fire management system according to an embodiment;

FIG. 2 is a flowchart of a fire mapping system according to an embodiment;

FIG. 3 is a map of a current fire boundary and a predicted fire boundary, according to an embodiment; and

FIG. 4 is a flowchart of a fire modeling system according to an embodiment.

### DETAILED DESCRIPTION

Embodiments of the present disclosure are described in detail with reference to embodiments thereof as illustrated in the accompanying drawings. References to “one embodiment,” “an embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Spatially relative terms, such as “beneath,” “below,” “lower,” “above,” “on,” “upper,” “opposite” and the like, may be used herein for ease of description to describe one element or feature's relationship to another element(s) or feature(s) as illustrated in the figures. The spatially relative terms are intended to encompass different orientations of the device in use or in operation in addition to the orientation depicted in the figures. The apparatus may be otherwise oriented (e.g., rotated 90 degrees or at other orientations) and the spatially relative descriptors used herein may likewise be interpreted accordingly.

The term “about” or “substantially” as used herein indicates the value of a given quantity that can vary based on a particular technology. Based on the particular technology, the term “about” or “substantially” can indicate a value of a given quantity that varies within, for example, 1-15% of the value (e.g., ±1%, ±2%, ±5%, ±10%, or ±15% of the value). As used herein, the term “between” indicates an inclusive range. The following examples are illustrative, but not limiting, of the present embodiments. Other suitable modifications and adaptations of the variety of conditions and parameters normally encountered in the field, and which would be apparent to those skilled in the art, are within the spirit and scope of the disclosure.

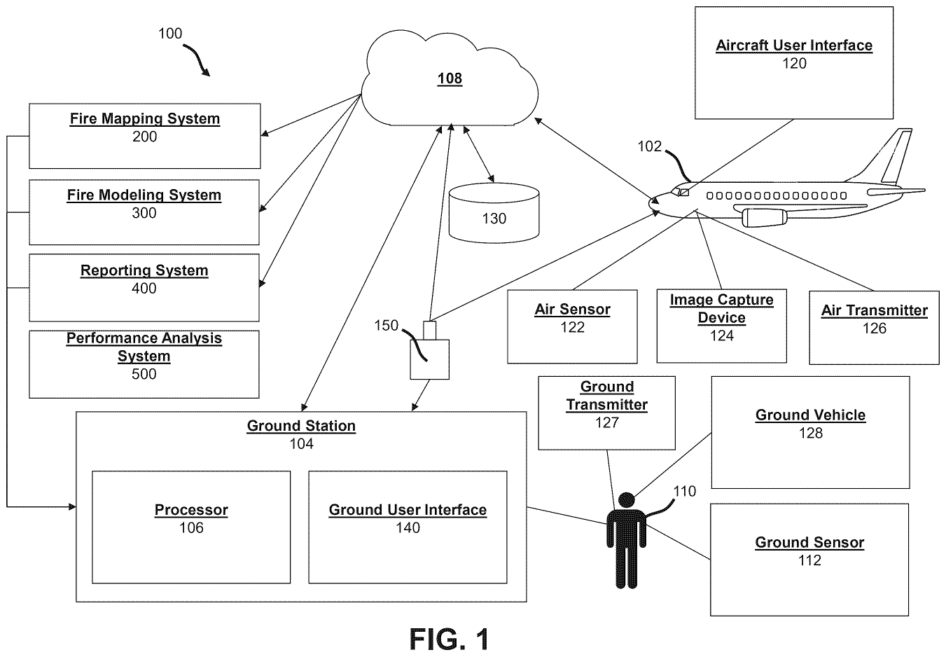

Referring to FIG. 1, the present disclosure includes a fire management system 100 configured to provide firefighting personnel 110 with real-time analytics and recommendations to contain and extinguish a fire (e.g., a wildfire). In some embodiments, fire management system 100 is configured to recommend to firefighting personnel 110, suppression methods and/or tactics including, for example, aircraft types (e.g., planes, helicopters, etc.) and deployment locations for firefighting materials (e.g., fire retardant such as water and/or other fire suppression materials such as foam, water enhancers, gels, etc.) based on, for example, current and predicted characteristics of the fire (e.g., growth rate, direction, etc.) and/or current suppression efforts (e.g., location of firefighting personnel 110 and firefighting equipment, location, number, and/or types of aircraft deployed, fire area rate of change, rate of spread, etc.) In some embodiments, the fire area rate of change corresponds to, for example, an increase or a decrease in the area of the fire over a time period (e.g., 100 square-meters per hour, 10 square-meters per minute, etc.) In some embodiments, the rate of spread corresponds to, for example, an increase or decrease in the distance between the leading edge of the fire and the origin of the fire, or an increase or decrease in the perimeter of the fire (e.g., 1.5 chains (66 ft.) per hour, 100 feet per minute, 5 miles per hour, etc.)

In some embodiments, fire management system 100 is configured to provide recommendations regarding, for example, an appropriate (e.g., change in) coverage level. For firefighting operations, coverage level (e.g., 1, 2, 3, 4, 5, 6, etc.) generally refers to the gallons of firefighting material (e.g., water, retardant, etc.) deployed over an area (e.g., 100 feet squared). For example, a coverage level 1 can refer to 1 gallon of retardant per 100 feet squared, and a coverage level 3 can refer to 3 gallons of retardant per 100 feet squared. A recommendation to increase the coverage level can assist firefighting personnel 110 in containing and extinguishing the fire. A recommendation to increase the coverage level to the minimum level that can, for example, contain the fire in a particular region of the fire, can assist firefighting personnel 110 in containing the fire while maintaining sufficient resources (e.g., aircraft, fire trucks, firefighting personnel 110, retardant, etc.) to contain and extinguish other regions of the fire.

In some embodiments, fire management system 100 includes an aircraft 102 configured to survey a fire (e.g., fly over the fire). In some embodiments, aircraft 102 is a fixed-wing airplane. In some embodiments, aircraft 102 is a rotor craft. In some embodiments, aircraft 102 is an unmanned aerial vehicle. In some embodiments, aircraft 102 is an air tanker configured to deploy fire retardant on a fire. In some embodiments, aircraft 102 is deployed for surveillance and is not equipped to deploy fire retardant. In some embodiments, aircraft 102 is configured to both deploy fire retardant and to provide surveillance of the fire.

In some embodiments, fire management system 100 includes a ground station 104 configured to display information to firefighting personnel 110. For example, ground station 104 can display information on a screen (e.g., on a computer, laptop, tablet, phone, etc.) associated with the fire and active suppression efforts.

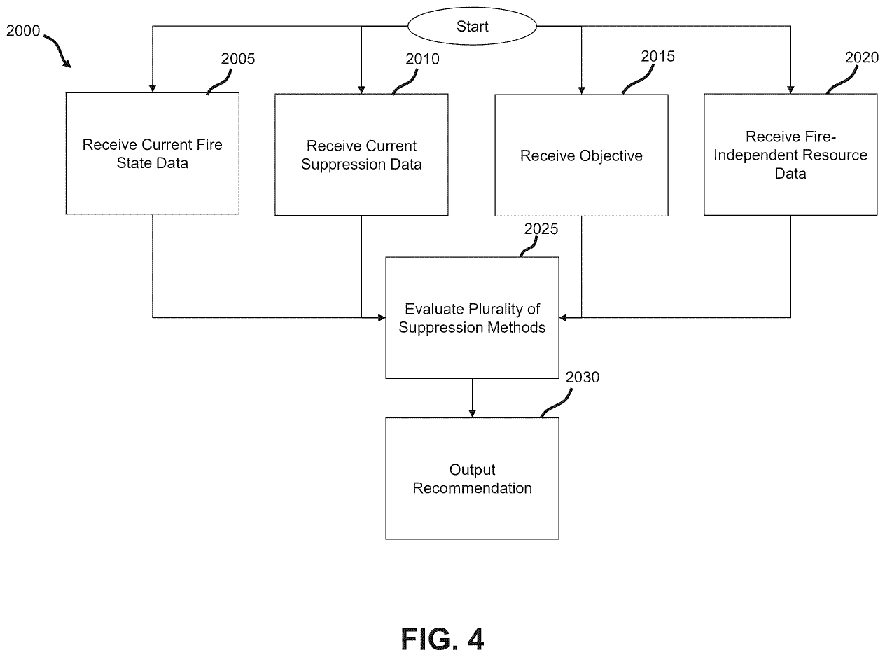

In some embodiments, fire management system 100 includes a computing system having a processor 106 configured to receive signals corresponding to characteristics of the fire (e.g., area, direction of spread, growth rate, etc.) and environmental conditions (e.g., ambient temperature, humidity, wind direction, wind velocity, fire weather index, cloud coverage, dew point, topography, etc.) from aircraft 102 (e.g., via an air transmitter 126), a ground based weather station 150, and/or firefighting personnel 110 (e.g., via a ground transmitter 127). In some embodiments, ground based weather station 150 includes an imaging device (e.g., camera, thermal camera, infrared camera, multispectral sensor, synthetic aperture radar, etc.). In some embodiments, processor 106 is configured to receive information regarding deployed aircraft (e.g., aircraft type, fuel type, fuel quantity, position, suppression capabilities, retardant load, etc.) from aircraft 102, firefighting personnel 110, satellite transmissions, and/or automated aircraft reporting systems (e.g., Automatic Dependent Surveillance Broadcast (ADS-B)) via, for example, a transmitter 126. In some embodiments, processor 106 is configured to output characteristics of the fire (e.g., area, growth rate, intensity, etc.) and recommendations (e.g., as discussed below relative to FIG. 4) to assist firefighting personnel 110 in containing and extinguishing the fire. In some embodiments, processor 106 is disposed in or at ground station 104. In some embodiments, processor 106 is external to ground station 104 (e.g., cloud based computing). In some embodiments, processor 106 is on aircraft 102. In some embodiments, processor 106 includes multiple processors.

In some embodiments, aircraft 102 includes an air sensor 122 configured to output one or more signals corresponding to characteristics of the fire (e.g., the fire size (e.g., area), the fire growth rate, etc.) and/or environmental conditions (e.g., wind velocity, humidity, ambient temperature, topography etc.). In some embodiments, air sensor 122 includes a plurality of sensors. In some embodiments, each air sensor 122 of the plurality of sensors is configured to output signals corresponding to a measurement and/or characteristic of the fire. In some embodiments, for example, processor 106 is configured to receive a signal corresponding to the area of the fire from a first sensor, and processor 106 is configured to receive a second signal corresponding to wind velocity from a second sensor of air sensor 122.

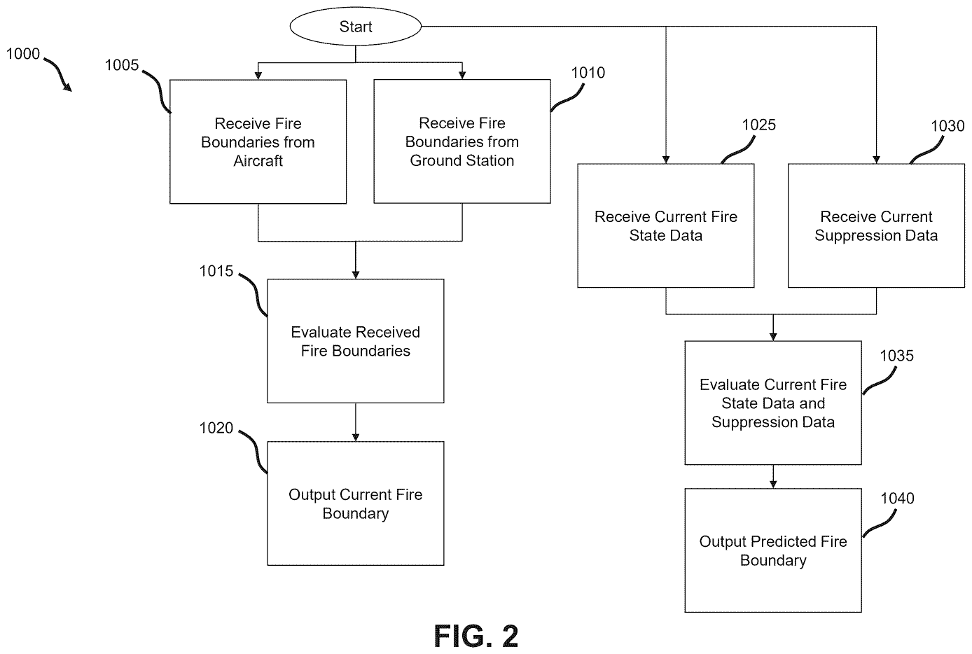

In some embodiments, aircraft 102 includes a transmitter 126 configured to output a signal to, for example, ground station 104. In some embodiments, transmitter 126 is configured to output a signal corresponding to current characteristics of the fire and/or predicted characteristics of the fire (as discussed for example relative to FIG. 2), and/or a recommended suppression method (as discussed for example relative to FIG. 4). In some embodiments, transmitter 126 is configured to transmit data through a Very High Frequency (VHF) Data Link, a High Frequency (HF) Data Link, a cellular network, or any data link or network operable to facilitate communication between aircraft 102 and ground station 104 and/or another aircraft.

In some embodiments, fire management system 100 includes a ground sensor 112 configured to output one or more signals corresponding to characteristics of the fire (e.g., the fire size (e.g., area), the fire growth rate, etc.) and/or environmental conditions (e.g., wind velocity, humidity, ambient temperature, topography, etc.). In some embodiments, firefighting personnel 110 carry ground sensor 112 and/or ground sensor 112 is disposed in a ground vehicle (e.g., fire truck). In some embodiments, ground sensor 112 includes a plurality of sensors. In some embodiments, each ground sensor 112 of the plurality of sensors is configured to output signals corresponding to a measurement and/or characteristic of the fire. In some embodiments, for example, processor 106 is configured to receive a signal corresponding to the area of the fire from a first sensor, and processor 106 is configured to receive a second signal corresponding to wind velocity from a second sensor of ground sensor 112.

In some embodiments, processor 106 is configured to receive signals output by ground sensor 112 and/or air sensor 122. In some embodiments, processor 106 is configured to determine a characteristic of the fire and/or the environment based on signals output by ground sensor 112 and/or air sensor 122. In some embodiments, processor 106 is configured to filter signals output by ground sensor 112 and/or air sensor 122. In some embodiments, processor 106 is configured to filter signals output by ground sensor 112 and/or air sensor 122 by, for example, determining a weighted average between values (e.g., temperature, wind velocity, humidity, fire growth rate, etc.) corresponding to signals output by ground sensor 112 and/or air sensor 122. In some embodiments, processor 106 is configured, for example, to assign more weight to signals output by ground sensor 112 relative to air sensor 122. In some embodiments, processor 106 is configured, for example, to assign more weight to signals output by air sensor 122 relative to ground sensor 112.

In some embodiments, aircraft 102 includes an image capture device 124 configured to capture images and/or videos. In some embodiments, processor 106 is configured to receive images and/or videos from image capture device 124. In some embodiments, image capture device 124 is an infrared, multispectral, and/or thermal imaging camera. In some embodiments, image capture device 124 is a radar (e.g., synthetic aperture radar). In some embodiments, for example, firefighting personnel 110 view a thermal map of the fire via ground station 104.

In some embodiments, aircraft 102 (e.g., via transmitter 126) is configured to transmit signals corresponding to characteristics of the fire (e.g., area, location, growth rate, intensity, etc.) to ground station 104 via a communication network 108 (e.g., Radio-frequency, Satcom, 3G, 4G, 5G, LTE, Wi-Fi, etc.). In some embodiments, ground station 104 is configured to receive signals corresponding to characteristics of the fire (e.g., area, location, growth rate, intensity, etc.) via communication network 108. In some embodiments, ground station 104 is configured to receive input from firefighting personnel 110 (e.g., disposed in a ground vehicle 128) regarding fire characteristics and current suppression efforts via communication network 108 and/or via a ground user interface 140.

In some embodiments, ground station 104 is an enclosed area (e.g., temporary field structure, office, fire station, etc.). In some embodiments, ground station 104 is a mobile device (e.g., cell phone, tablet, etc.). In some embodiments, ground station 104 is a vehicle (e.g., fire truck, car, etc.).

In some embodiments, ground station 104 includes ground user interface 140. In some embodiments, aircraft 102 includes an aircraft user interface 120. In some embodiments, ground user interface 140 and/or aircraft user interface 120 are integrated into a mobile device (e.g., cell phone, tablet, laptop, etc.). In some embodiments, ground user interface 140 and/or aircraft user interface 120 are web-based, such that, for example, firefighting personnel 110 can access aircraft user interface 120 and/or ground user interface 140, for example, via a web browser installed on a mobile device.

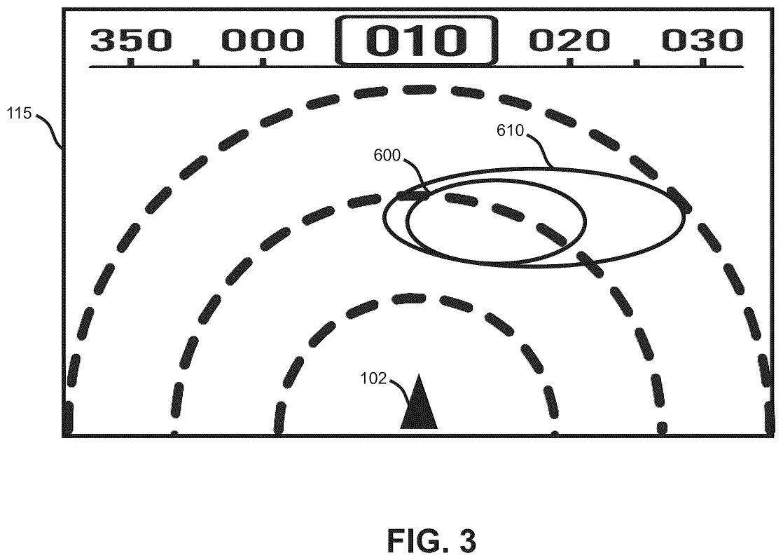

In some embodiments, ground user interface 140 is integrated into firefighting equipment (e.g., fire truck) and is configured to receive signals from aircraft 102 and/or ground station 104 via communication network 108. In some embodiments, aircraft user interface 120 and/or ground user interface 140 are configured to display positions of firefighting resources (e.g., personnel, equipment, etc.), the estimated time to deploy firefighting resources to the fire, the types of deployed firefighting resources (e.g., aircraft, bull dozer, fire truck, hand line length, etc.), location and size of control lines (e.g., constructed or natural fire barrier, such as dozer lines, retardant lines, water drops, etc.), the amount of firefighting personnel 110 deployed to the fire, the quantity of water and/or fire retardant available on a particular resource (e.g., air tanker), the fuel remaining in a particular resource (e.g., aircraft), the location of fuel, water and/or fire-retardant refilling station/reserves, the estimated time for a firefighting resource to refill fuel, water, and/or fire retardant, the remaining time in the duty shift, a current fire map (e.g., as discussed below relative to FIGS. 2-3) and/or a projected fire map (e.g., as discussed below relative to FIGS. 2-3). In some embodiments, for example, ground user interface 140 displays an indication that coverage level 4 with a first retardant is not effective, and ground user interface 140 displays a recommendation (e.g., as discussed below relative to FIG. 4) to increase to coverage level 6 with a second retardant. In some embodiments, ground user interface 140 displays reasons (e.g., text message) explaining and/or summarizing the recommendation, such as the recommendation is based on the current fire and current suppression efforts and/or that the recommendation is based on successful suppression efforts in a previous fire (e.g., via fire database 130) that included similar environmental conditions (e.g., temperature, humidity, vegetation, topography, etc.)

In some embodiments, ground user interface 140 is configured so firefighting personnel 110 located on the ground (e.g., incident commander) can view analytics (e.g., via a graphical dashboard) corresponding to characteristics of the fire and current suppression efforts. In some embodiments, ground user interface 140 is configured to display a recommendation (e.g., as discussed relative to FIG. 4) to, for example, increase the coverage level in a particular region of the fire, reposition an aircraft to be closer to the fire in anticipation of the fire growing, bulldoze a line of vegetation in a particular region of the fire to build a fire wall, and/or to deploy an aircraft to a particular region of the fire. Real-time analytics concerning characteristics of the fire, and recommendations to improve current firefighting efforts can assist firefighting personnel 110 in containing and extinguishing wildfires.

In some embodiments, aircraft user interface 120 and ground user interface 140 include user-specific views. In some embodiments, for example, ground user interface 140 includes a first view configured for a fire manager, and a second view configured for an incident commander. In some embodiments, the first view and the second view include different features (e.g., displayed analytics, recommendations, etc.) based on the particular firefighting personnel 110 accessing, for example, ground user interface 140. In some embodiments, ground user interface 140 and/or aircraft user interface 120 are configured to mitigate screen clutter and information overload. In some embodiments, aircraft user interface 120 and/or ground user interface 140 include removable or replaceable layers so firefighting personnel 110 can, for example, selectively declutter aircraft user interface 120 and/or ground user interface 140 based on the information that is relevant to them. In some embodiments, for example, ground user interface 140 includes a first layer configured to display a map of the fire perimeter (e.g., as discussed below relative to FIG. 2), a second layer configured to display a map of a projected fire perimeter (e.g., as discussed below relative to FIG. 2), a third layer configured to display the location of firefighting resources (e.g., air tankers, ground equipment, firefighting personnel 110, etc.), and/or a fourth layer configured to display the location of residents, structures, and/or infrastructure.

In some embodiments, fire management system 100 includes a fire database 130. In some embodiments, fire database 130 includes historical data corresponding to for example, prior fires (e.g., locally, regionally, nationally) and the impact of suppression methods.

Coordinating inputs from multiple sources (e.g., one or more aircraft 102 (e.g., via transmitter 126), one or more firefighting personnel (e.g., via one or more ground transmitters 127), one or more air sensors 122, one or more ground sensors 128, one or more image capture devices 124, and/or one or more weather stations 150, etc.) to, for example, output a recommended fire suppression method, is technically challenging because communication networks can have intermittent outages, sensors can experience diminished performance (e.g., low accuracy, faults, etc.), aircraft can experience diminished performance (e.g., engine failure, retardant drop system fails), ground vehicles can have diminished performance (e.g., hose damage), etc. In some embodiments, for example, processor 106 is configured to receive a confidence level corresponding to a signal output by at least one of air sensor 122, image capture device 124, air transmitter 126, ground transmitter 127, or weather station 150. In some embodiments, for example, processor 106 is configured to receive a Horizontal Figure of Merit (HFOM), corresponding to a 95% confidence level associated with the horizontal GPS position output by transmitter (e.g., an ADS-B transmitter).

In some embodiments, fire mapping system 200, fire modeling system 300, reporting system 400, and/or performance analysis system 500 are configured to receive the confidence level output by at least one of air sensor 122, image capture device 124, air transmitter 126, ground transmitter 127, or weather station 150. In some embodiments, for example, fire modeling system 300 is configured to output a recommended suppression method (for example, as discussed in detail relative to FIG. 4), based at least in part on the confidence levels discussed here. In some embodiments, fire modeling system 300, for example, assigns different weights to inputs received (e.g., via air sensor 122, image capture device 124, air transmitter 126, ground transmitter 127, weather station 150, etc.) based on the confidence level. For example, if processor 106 receives a poor HFOM value (e.g., HFOM greater than 500 ft.) from a first aircraft and processor 106 receives a better HFOM value (e.g., HFOM less than 20 ft.) from a second aircraft, fire modeling system 300 can output a fire suppression method that includes deploying the second aircraft for a narrowly targeted retardant drop (e.g., bordering residential homes in an urban area) and includes deploying the first aircraft for a broad retardant drop (e.g., to unpopulated hills or forests surrounding an urban area). As another example, fire mapping system can generate a detailed a fire map (as shown for example in FIG. 3) that includes boundaries shown with greater detail where the corresponding fire location is, based on output from a sensor having a high confidence level (e.g., HFOM less than 20 ft.) to indicate that the fire map is particularly accurate in certain areas.

Considering the confidence level associated with the inputs disclosed herein to, for example, output a recommended suppression method, facilitates an aerial firefighting management system that incorporates inputs from distributed vehicles and sensors to provide timely insights that reduce the time and/or resources required to extinguish and/or retain a fire.

In some embodiments, as shown in FIGS. 1-2, fire management system 100 includes a fire mapping system 200 configured to execute a fire mapping process 1000. In some embodiments, processor 106 is configured to execute fire mapping process 1000.

In some embodiments, as shown for example in FIG. 2, fire mapping system 200 is configured to receive 1005 (e.g., via communication network 108) current fire boundary data (e.g., latitude and longitude coordinates) from aircraft 102 (e.g., input by the flight crew, and/or signals corresponding to the location of the fire from air sensor 122 and/or image capture device 124, etc.). In some embodiments, fire mapping system 200 is configured to receive 1010 (e.g., via communication network 108 and/or through a wired connection) current fire boundary data (e.g., latitude and longitude coordinates) from ground station 104 (e.g., via input by firefighting personnel 110). In some embodiments, fire mapping system 200 is configured to evaluate 1015 the fire boundaries received from aircraft 102 and/or ground station 104. In some embodiments, evaluating 1015 fire boundaries received from aircraft 102 and/or ground station 104 includes filtering discrepancies (e.g., weighted average). In some embodiments, fire mapping system 200 outputs 1020 (e.g., displays on ground user interface 140) a current map of the fire perimeter.

In some embodiments, fire mapping system 200 is configured to output a predicted boundary for an active fire based on, for example, the current boundaries, wind, humidity, temperature, current suppression efforts (e.g., location of firefighting personnel 110, location, number, type, fuel type, fuel quantity, retardant load, etc. of aircraft deployed to fight the fire, fire area rate of change, rate of spread, control lines, etc.) and/or the location of fuel, water and/or fire-retardant refilling station/reserves. In some embodiments, fire mapping system 200 is configured to output a predicted boundary for an active fire based on historical data (e.g., via fire database 130) with similar environmental conditions (e.g., wind, temperature, humidity, vegetation, topography, etc.), firefighting resources (e.g., number, type, fuel type, fuel quantity, retardant load, and location of aircraft, number and location of firefighting personnel, etc.) and/or fires that were close in proximity to the active fire. In some embodiments, fire mapping system 200 is configured to receive 1025 current fire state data (e.g., via communication network 108 from aircraft 102 and/or from satellite(s)). In some embodiments, fire mapping system 200 is configured to receive 1035 current suppression data (e.g., via communication network 108 from ground station 104). In some embodiments, current fire state data includes information based on signals output by air sensor 122 (e.g., wind velocity, humidity, ambient temperature, etc.) and/or image capture device 124. In some embodiments, current suppression data includes the location of firefighting personnel 110, location, number, type, fuel type, fuel quantity, retardant load, etc. of aircraft deployed, coverage level, rate of spread, and/or the fire area rate of change.

In some embodiments, fire mapping system 200 is configured to evaluate 1035 current fire state data and suppression data. In some embodiments, evaluating 1035 current fire state data and suppression date includes using models and analytical methods to predict fire growth rate and direction considering current fire state data and suppression efforts. In some embodiments, fire mapping system 200 is configured to output 1040 (e.g., display on ground station 104) a predicted fire boundary.

In some embodiments, as shown for example, in FIG. 3, fire mapping system 200 is configured to output 1020 the current fire boundary 600 and is configured to output 1040 the predicted fire boundary 610 (e.g., in different colors, shades, and/or lines on the same display, etc.). In some embodiments, fire mapping system 200 is configured to output 1020 current fire boundary 600 and/or output 1040 predicted fire boundary 610 on a user interface 115 (e.g., aircraft user interface 120 and/or ground user interface 140).

In some embodiments, as shown for example in FIG. 1 and FIG. 4, fire management system 100 includes a fire modeling system 300 configured execute a suppression recommendation method 2000. In some embodiments, fire modeling system 300 is configured to output a recommended suppression method and/or combination of multiple suppression methods based on predicted changes (e.g., intensity, size, location, direction, etc.) in an active fire considering, for example, a plurality of different suppression efforts/combinations of suppression efforts (e.g., location of firefighting personnel 110, number and/or type of aircraft deployed, ground vehicle locations, amount of retardant deployed, fire area rate of change, rate of spread, coverage levels, etc., and/or any combination thereof).

In some embodiments, fire modeling system 300 is configured to receive current fire state data 2005. In some embodiments, current fire state data includes information based on signals output by air sensor 122 (e.g., wind velocity, humidity, ambient temperature, etc.) and/or image capture device 124. In some embodiments, current fire state data includes information based on signals output by ground based weather station 150. In some embodiments, fire modeling system 300 is configured to receive 2010 current suppression data. In some embodiments, fire modeling system 300 is configured to receive 2015 (e.g., via communication network 108 from ground station 104) an input (e.g., on aircraft user interface 120 and/or ground user interface 140) corresponding to an objective (e.g., mitigate property damage, mitigate loss of life, mitigate fire surface area, etc.). In some embodiments, fire modeling system 300 is configured to receive 2020 fire-independent resource data (e.g., available retardant types from a retardant database, characteristics of different fire retardants such as viscosity and chemistry, etc.).

In some embodiments, fire modeling system 300 is configured to evaluate 2025 a plurality of suppression methods and/or combinations of suppression methods. In some embodiments, evaluating 2025 a plurality of suppression methods includes, for example, executing a plurality of simulations (e.g., Monte Carlo methods, agent-based modeling, discrete event simulations, system dynamic modelling) to estimate future characteristics (e.g., after a predetermined time, such as 5 minutes, 30 minutes, 1 hour, 2 hours, 5 hours, 12 hours, 24 hours, etc.) of the fire based on current fire state data and/or current suppression data.

In some embodiments, evaluating 2025 a plurality of suppression methods includes scoring the predicted results corresponding to each suppression method (and/or combination of suppression methods) based on an objective (e.g., mitigate property damage, mitigate loss of life, mitigate fire surface area, etc.). In some embodiments, scoring the predicted results includes, for example, comparing current fire state data (e.g., current growth rate) with predicted (e.g., by executing a plurality of simulations) characteristics of the fire (e.g., future growth rate) and assigning a score to the result based on, for example, predetermined criteria (e.g., a first value corresponding to a first percentage decrease in growth rate, a second value corresponding to a second percentage decrease in growth rate, etc.). In some embodiments, scoring the predicted results includes assigning weights to, for example, characteristics of the fire. In some embodiments, for example, scoring the predicted results includes assigning a first weight to a first characteristic of the fire and a second weight to a second characteristic of the fire. Weighting characteristics of the fire can, for example, output recommendations of suppression methods that are more likely to mitigate higher priority (e.g., as determined by firefighting personnel 110, hard-coded, etc.) fire characteristics.

In some embodiments, evaluating 2025 a plurality of suppression methods includes applying an artificial intelligence system to determine expected outcomes (e.g., fire containment rate, damage to structures, loss of life, etc.) for each of the plurality of suppression methods (and/or combination of suppression methods).

In some embodiments, evaluating 2025 a plurality of suppression methods (and/or combination of suppression methods) includes comparing the current fire state data to historical suppression data corresponding to a prior fire. For example, if the current fire state data indicates that the coverage level is a 2 and the fire is continuing to grow, evaluating 2025 a plurality of suppression methods can include comparing the current fire state data to historical data (e.g., stored in fire database 130) indicating that a coverage level 4 was effective to contain and/or extinguish a similar fire (e.g., similar climate, fire surface area).

In some embodiments, evaluating 2025 a plurality of suppression methods includes comparing the current fire state data (e.g., for a particular location of the fire, such as a southern region of the fire) to current fire state data in a different location (e.g., northern region of the fire). For example, aircraft 102 can supply (e.g., via air sensor 122 and/or image capture device 124) current fire state data for a first region of the fire, and a ground crew can supply (e.g., via input on ground user interface 140 and/or via ground sensor 112) current fire state data for a second region of the fire. In some embodiments, evaluating 2025 a plurality of suppression methods includes comparing current fire state data in the first region and current suppression methods in the first region, with current fire state data in the second region and current suppression methods in the second region. For example, the first region can include suppression methods corresponding to a coverage level 2 and the second region can include suppression methods corresponding to a coverage level 4. If, for example, the coverage level in the first region is not effective, but the coverage level in the second region is effective in containing the fire, fire modeling system 300 can recommend increasing the coverage level in the first region to a level 4 based on the known effectiveness of suppression methods corresponding to level 4 in the second region.

Comparing current suppression methods and fire progress in a particular region with historical data and current data for a different region of the same fire can assist firefighting personnel 110 (e.g., incident commander) in deploying resources efficiently, as opposed to deploying an excessive response (e.g., coverage level 6 when coverage level 4 should be sufficient) in a particular region. Efficient deployment of resources for particular region of a fire can ensure sufficient resources are available to contain and extinguish other regions of the fire.

In some embodiments, fire modeling system 300 is configured to output 2030 (e.g., via ground station 104) a recommendation (e.g., suppression method or combination of suppression methods). In some embodiments, fire modeling system 300 outputs 2030 the recommendation as a text message on ground user interface 140 and/or aircraft user interface 120. In some embodiments, fire modeling system 300 outputs 2030 the recommendation as an annotated map (e.g., with labels indicating the location and type of recommended suppression effort) on ground user interface 140 and/or aircraft user interface 120. In some embodiments, fire modeling system 300 outputs 2030 the recommendation to aircraft 102 (e.g., via aircraft user interface 120) so, for example, the flight crew operating aircraft 102 can navigate aircraft 102 to a recommended location.

In some embodiments, as shown for example in FIG. 1, fire management system 100 includes a reporting system 400 configured to output signals corresponding to, for example, the current fire size, the number and location (e.g., GPS position) of firefighting personnel 110 assigned to the fire, the number and location (e.g., GPS position) of aircraft assigned to the fire, and/or the number of ground vehicles (e.g., fire trucks) assigned to the fire. In some embodiments, reporting system 400 is configured to output signals corresponding to active suppression efforts by vehicles (e.g., aircraft and/or ground vehicles) deployed to contain and/or extinguish the fire. In some embodiments, reporting system 400 is configured to output signals corresponding to recommendations (e.g., by fire modeling system 300).

In some embodiments reporting system 400 is configured to output a length and location of a fire retardant line created on the ground by an aircraft (e.g., aircraft drop length). In some embodiments reporting system 400 is configured to output a length, width, and location of a line of vegetation cleared by, for example, ground personnel or a bulldozer, to create a firebreak (e.g., dozer line). In some embodiments, reporting system 400 is configured to output a length of hose that firefighting personnel 110 on the ground (e.g., firefighters) are using to contain and/or extinguish the fire (e.g., hand line). In some embodiments, reporting system 400 is configured to output the amount (e.g., gallons) of fire retardant (e.g., foam, water, etc.) deployed by, for example, an aircraft or a ground vehicle (e.g., fire truck).

In some embodiments, reporting system 400 is configured to output a categorized list of active suppression efforts. In some embodiments, reporting system 400 is configured to categorize suppression efforts based on, for example, a goal associated with each suppression effort (e.g., contain the fire perimeter, protect structures, mitigate loss of life, etc.). In some embodiments, reporting system 400 is configured to categorize suppression efforts based on user input (e.g., via aircraft user interface 120 and/or ground user interface 140). In some embodiments, reporting system 400 is configured to output categorized suppression efforts on aircraft user interface 120 and/or ground user interface 140. In some embodiments, reporting system 400 outputs the categorized suppression efforts as text labels on, for example, ground user interface 140. In some embodiments, for example, ground user interface 140 is configured to display a map of the fire, with suppression efforts (e.g., air tanker) labelled on the map, and a category label (e.g., protect structures) displayed next to the suppression effort label.

In some embodiments, as shown for example in FIG. 1, fire management system 100 includes a performance analysis system 500. In some embodiments, performance analysis system 500 includes performance results indicating how well firefighting personnel 110 managed or are managing a fire. In some embodiments, the performance results include, for example, the total cost, cost per gallon, cost of forest burned (e.g., environmental cost for biomass burnt, carbon emitted, etc.), amount of property and/or land damage (e.g., biomass burnt, carbon emitted, etc.), and suppression efforts used to contain and extinguish a fire.

In some embodiments, performance analysis system 500 is configured to compare the performance results with projections (e.g., by fire modeling system 300) of what the performance results would have been absent suppression efforts and/or if different suppression methods were used to contain and extinguish the fire. In some embodiments, performance analysis system 500 is configured to determine the efficiency and/or effectiveness of, for example, individual suppression efforts. Firefighting personnel 110 reviewing the efficiencies and effectiveness output by performance analysis system 500 can identify, for example, the suppression efforts that were efficient and/or effective in mitigating the fire and the suppression efforts that were not efficient and/or effective. The efficiencies and effectiveness output by performance analysis system 500 can guide future decision making by firefighting personnel 110. In some embodiments, performance results, efficiencies, and effectiveness determined by performance analysis system 500 are saved in a database for further analysis and to guide future decision making by firefighting personnel 110.

In some embodiments, fire mapping system 200, fire modeling system 300, reporting system 400 and/or performance analysis system 500 is configured to execute at a predetermined frequency (e.g., such as every minute, 5 minutes, 10 minutes, 60 minutes, 120 minutes, etc.) and/or on-demand (e.g., based on input to ground user interface 140 and/or aircraft user interface 120). In some embodiments, fire mapping system 200, fire modeling system 300, reporting system 400 and/or performance analysis system 500 are configured to execute at the same frequency or at different frequencies. In some embodiments, at least one of fire mapping system 200, fire modeling system 300, reporting system 400 and/or performance analysis system 500 is configured to execute at one or more frequencies and at least one of fire mapping system 200, fire modeling system 300, reporting system 400 and/or performance analysis system 500 is configured to execute on demand.

In some embodiments, for example, fire mapping system 200 is configured to execute at a first frequency, fire modeling system 300 is configured to execute at a second frequency, reporting system 400 is configured to execute at a third frequency, and performance analysis system 500 is configured to execute at a fourth frequency. In some embodiments, for example, fire mapping system 200 is configured to execute on demand (e.g., based on input to ground user interface 140 and/or aircraft user interface 120) and reporting system 400 is configured to execute at a predetermined frequency.

In some embodiments, fire management system 100 is configured so firefighting personnel 110 can monitor resources. For example, in some embodiments, firefighting personnel 110 can view (e.g., on ground user interface 140) that there are 10 helicopters deployed to a fire that they are all the same type and that 8 of the helicopters are taking 1,000 gallon retardant loads and 2 are taking 600 gallon retardant loads. In some embodiments, fire management system 100 is configured to highlight (e.g., on ground user interface 140) outliers (e.g., indicating the 2 helicopters carrying 600 gallon retardant loads) and firefighting personnel 110 (e.g., government agency) can provide instructions to manage the performance of the outliers. In some embodiments, fire management system 100 is configured to indicate performance indications such as dispatch time, retardant quantity dropped, pilot duty time, unserviceability rate, etc.

In some embodiments, fire management system 100 is configured to evaluate the firefighting assets deployed to the fire and output (e.g., via ground user interface 140) performance based feedback based on, for example, fire mapping system 200. For example, if 10 aircraft are deployed to a fire, and fire management system 100 determines that 9 of the aircraft are effectively holding a designated region of the fire, but the fire continues to burn in a particular region, fire management system 100 can indicate (e.g., on ground user interface 140 and/or aircraft user interface 120) that the aircraft deployed to that region is not effective. In another example, if one ground crew is building a slower line than other nearby ground crews, and the terrain and vegetation is similar, fire management system 100 can indicate (e.g., on ground user interface 140) which ground crew is more/less effective.

In some embodiments, government agencies can access data corresponding to suppression methods and effectiveness (e.g., via reporting system 400 and/or performance analysis system 500). Providing government agencies with access to data computed and stored by fire management system 100 can allow agencies to calculate the total suppression cost in real time (or after the fact) and compare it to what the projected fire would have done if unsuppressed, and/or compare the agency assessment to the results from performance analysis system 500.

In some embodiments, fire management system 100 provides recommendations (e.g., via fire modeling system 300) on pre-positioning firefighting assets (e.g., aircraft, ground vehicles, crew, etc.) based on, for example, previous fire behavior, fire weather index, temperature, relative humidity, fuel moisture content, resource availability, etc.

In some embodiments, fire management system 100 is configured to make recommendations (e.g., via fire modeling system 300) to pilots flying deployed aircraft regarding suggested areas to drop retardant (e.g., water and/or other fire suppression materials such as foam, gel, water enhancers) to improve the chance of a successful outcome (e.g., mitigating and/or extinguishing the fire.) In some embodiments, aircraft 102 is configured to automatically execute a flight plan based on the recommendation. In some embodiments, for example, fire modeling system 300 is configured to output GPS coordinates, altitude, etc. corresponding to a drop location, and aircraft 102 is configured to autonomously navigate to the prescribed location and execute the prescribed action (e.g., drop retardant). In some embodiments, fire management system 100 is configured to provide recommendation on retardant drop locations based on, for example, fire behavior, objectives (e.g., perimeter control, life protection, infrastructure protection, etc.), and/or based on input from firefighting personnel (e.g., incident commander, air attack, etc.).

In some embodiments, fire management system 100 is configured to receive signals from weather stations (e.g., ground based weather station 150). In some embodiments, fire management system 100 provides recommendations to pre-treat areas with, for example, retardant. In some embodiments, fire management system 100 is configured to monitor the time and environmental factors (e.g., rainfall) since an area was pre-treated, and provide recommendations to treat the area again to, for example, maintain an effective fire break.

In some embodiments, fire management system 100 is configured to output an efficiency and/or chance of success corresponding to existing fire breaks based on, for example, when they were cleared and what level they were cleared to. In some embodiments, fire management system 100 can provide recommendations corresponding to when corrective action needs to be taken to rehabilitate an area in order to increase efficiency and/or the chance of, for example, a firebreak successfully holding a fire. For example, if there is a fire break that was put in by a dozer and hand crew 3 years ago, and it is in a very high risk area, fire management system 100 can indicate that the area has grown significant brush, is a strategic hold point in a high risk area, and recommend that a crew go back and re-scrub the area.

In some embodiments, fire management system 100 includes unmanned aircraft configured to transmit data corresponding to an active fire and suppression methods to, for example, processor 106. In some embodiments, processor 106 is configured to automatically update predictions and recommendations (e.g., by executing fire mapping system 200, fire modeling system 300, reporting system 400, and/or performance analysis system) based on data from the unmanned aircraft.

In some embodiments, fire management system 100 is configured to employ machine learning methods (e.g., classification and regression tasks, clustering, dimensional reduction, Q-learning, SARSA, Deep Q-learning, etc.) and/or artificial intelligence algorithms to update fire mapping system 200, fire modeling system 300, reporting system 400, and/or performance analysis system 500 based on changing data and/or by comparing the predicted fire boundary (e.g., by fire mapping system 200) with the subsequent actual fire boundary and/or by comparing the predicted effectiveness of a suppression method (e.g., scored by fire modeling system 300) with the subsequent actual effectiveness of the recommended suppression method (e.g., assessed via performance analysis system 500).

In some embodiments, fire management system 100 is configured to monitor a radio frequency and provide corresponding recommendations. For example, if an air attack crew and/or ground crew comments on the quality of a retardant drop on a radio frequency (e.g., observing the drop was long, drifted, short, was in the wrong place, etc.), fire management system 100 (e.g., processor 106) can record and evaluate the transmission. In some embodiments, for example, processor 106 is configured to execute a natural language processing algorithm to convert audio transmitted on the radio frequency into text. In some embodiments, fire management system 100 is configured to evaluate data (e.g., look up table corresponding to retardant drop quality and observations transmitted on the radio frequency) corresponding to signals transmitted on the radio frequency to, for example, indicate performance metrics for particular aircraft, crews, maneuvers, procedures, etc.

In some embodiments, ground user interface 140 is configured to receive input from firefighting personnel 110 corresponding to feedback and/or evaluations of, for example, a particular retardant drop, procedure, ground crew, aircraft crew, etc. For example, in some embodiments, ground user interface 140 is configured to receive input corresponding to a missed retardant drop and/or that the retardant dropped burnt through, etc. In some embodiments, fire management system 100 includes a drop rating system corresponding to a quality of a retardant drop. In some embodiments, for example, the end user (e.g., government agency, air attack, incident commander) can provide feedback (e.g., on ground user interface 140) regarding the quality of a retardant drop based on, for example a numeric scale (e.g., 1-5). In some embodiments, fire management system 100 is configured to record the rating (e.g., via reporting system 400, performance analysis system 500 and/or fire database 130) to facilitate further evaluation/assessment.

In some embodiments, fire management system 100 facilitates assessment of investments made into firefighting resources. In some embodiments, for example, fire management system 100 is configured to output a projection (e.g., via fire mapping system 200 and/or fire modeling system 300) of damage to an area (e.g., acres burned, property damage, loss of life, etc.) if one or more firefighting resources (e.g., aircraft) were not deployed to the area. In some embodiments, fire management system 100 is configured to compare (e.g., via performance analysis system 500) the actual damage with the projected damage. In some embodiments, fire management system 100 is configured to conduct a cost-benefit analysis (e.g., via performance analysis system 500) comparing the actual financial cost of the fire and suppression efforts with a projected financial cost absent one or more firefighting resources. For example, a government agency can use results from performance analysis system 500 to justify costs of one of more firefighting resources.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

What is claimed is:

1. An aircraft, comprising:
a sensor configured to output a first signal corresponding to a characteristic of a fire; and
a processor configured to determine a current boundary of the fire based on the first signal, and configured to receive a second signal corresponding to current fire suppression data,
wherein the processor is configured to determine a recommended fire suppression method based on the current boundary of the fire and the current suppression data for the fire.

2. The aircraft of claim 1, wherein the aircraft comprises a transmitter configured to output a recommendation signal corresponding to the recommended fire suppression method.

3. The aircraft of claim 2, wherein the transmitter is configured to output the recommendation signal to a ground station, and wherein the ground station comprises a user interface configured to output the recommended fire suppression method.

4. The aircraft of claim 2, wherein the transmitter is configured to output the recommendation signal to a second aircraft.

5. The aircraft of claim 1, further comprising a user interface configured to output the recommended fire suppression method.

6. The aircraft of claim 5, wherein the user interface is configured to display the current boundary of the fire.

7. The aircraft of claim 1, wherein the sensor is an image capture device.

8. The aircraft of claim 1, wherein the aircraft is configured to automatically execute a flight plan corresponding to the recommended fire suppression method.

9. An aerial firefighting management system, comprising:
an aircraft, a ground station, and a computing device comprising a processor,
wherein the processor is configured to receive a first signal corresponding to current fire state data for a fire and a second signal corresponding to current fire suppression data, and
wherein the processor is configured to determine a recommended suppression method based on the current fire state data and the current fire suppression data.

10. The aerial firefighting management system of claim 9, wherein the processor is configured to determine a current fire boundary based on the current fire state data, and wherein the processor is configured to determine a predicted fire boundary based on the current fire state data and the current fire suppression data.

11. The aerial firefighting management system of claim 9, wherein the processor is disposed at the ground station.

12. The aerial firefighting management system of claim 10, wherein the ground station comprises a user interface configured to display the current boundary of the fire and the predicted boundary of the fire.

13. The aerial firefighting management system of claim 9, wherein the ground station is configured to receive input from the aircraft via a communication network.

14. The aerial firefighting management system of claim 9, wherein the ground station is configured to receive an input corresponding to a fire suppression objective, and wherein the processor is configured to determine the recommended suppression method based on the fire suppression objective.

15. The aerial firefighting management system of claim 9, wherein the current fire state data comprises a characteristic of the fire or an environmental condition.

16. The aerial firefighting management system of claim 15, wherein the characteristic of the fire comprises at least one of a surface area of the fire, a direction of spread, or a fire growth rate, and wherein the environmental condition comprises at least one of ambient temperature, humidity, wind direction, wind velocity, fire weather index, cloud coverage, dew point, or topography.

17. The aerial firefighting management system of claim 9, wherein the current suppression data comprises at least one of a location of firefighting personnel, a location of the aircraft, a quantity of fuel onboard the aircraft, a retardant type onboard the aircraft, a retardant load onboard the aircraft, a coverage level, a fire area rate of change, or a rate of spread.

18. The aerial firefighting management system of claim 9, wherein the recommended suppression method comprises a fire retardant coverage level.

19. The aerial firefighting management system of claim 9, wherein the recommended suppression method comprises a drop location for fire retardant.

20. The aerial firefighting management system of claim 9, wherein the recommended suppression method comprises a fire-retardant type and a fire-retardant load.

21. The aerial firefighting management system of claim 9, wherein the processor is configured to select the fire-retardant type from a plurality of predetermined fire-retardant types.

22. The aerial firefighting management system of claim 9, wherein the processor is configured to determine the recommended suppression method based on a confidence level associated with the first signal.

23. The aerial firefighting management system of claim 9, wherein the processor is configured to determine the recommended suppression method based on a prior suppression method result.

24. The aerial firefighting management system of claim 9, further comprising a performance analysis system configured to determine damage avoided by executing the recommended suppression method.

25. The aerial firefighting management system of claim 24, wherein the performance analysis system is configured to assign a score to a flight crew.

26. The aerial firefighting management system of claim 9, wherein the aircraft comprises a first user interface, and the ground station comprises a second user interface, wherein the first user interface comprises a first layer based on an assigned role of the aircraft, and wherein the second user interface comprises a second layer based on an assigned role of the ground station.
